(19) United States
(12) Patent Application Publication
(10) Pub. No.: US 2011/0320286 A1
(43) Pub. Date: Dec. 29, 2011

(54) System And Method For Integrating An Ad Banner With A Calling Application

(75) Inventors: David Shai ZOHAR, Moshav Mishmeret (IL); Eli Ido ZOHAR, Tel Aviv (IL)

(73) Assignee: CALLINGBANNERS LTD., Moshav Mishmeret (IL)

(21) Appl. No.: 13/220,045

(22) Filed: Aug. 29, 2011

Related U.S. Application Data
(63) Continuation-in-part of application No. 12/812,241, filed on Jul. 9, 2010.
(60) Provisional application No. 61/006,379, filed on Jan. 10, 2008.

(51) Int. Cl. G06Q 30/00

(52) U.S. Cl. 705/14.72

(57) ABSTRACT

A method, a system and a module method of creating enhanced banners, each comprising content and functionality of an original ad banner (e.g. rich media file) and a calling application enabling users to initiate a call with an advertiser, associated with the original and enhanced banners. The system, module and method may enable integrating the original code and content of said original banner with the calling application; and creating a new enhanced banner, which is a new RMF enabling the combined operative functioning and content of the calling application and the banner, where the new created enhanced banner enables a user to initiate a call between the advertiser and the user by operating the calling application in the enhanced banner.

### CROSS REFERENCE TO RELATED APPLICATION

This application claims the benefit of U.S. utility patent application Ser. No. 12/812,241 filed on Jul. 9, 2010, which claims the benefit of PCT application No. PCT/IL2009/000032 filed 8 Jan. 2009, which claims the benefit of U.S. Provisional Patent Application 61/006,379, filed Jan. 10, 2008, which is incorporated herein by reference in its entirety.

### BACKGROUND

1. Field of the Invention

The present invention generally relates to the field of ad banners of rich media files and more particularly to methods and systems for integrating ad banners with calling applicability.

2. Related Art

Ad banners usually comprise media content data such as text, animation (Flash), video and/or audio content data. Most ad banners are managed by one or more servers and can be embedded in one or more network pages of different websites.

Advertisers such as services and products providers often use banner for advertising their services and/or products online by enabling users, using one network page or a website, where an ad banner is published, to enter (link) to the advertiser's website or network page, view more information relating to the advertiser and/or purchase products and/or services by clicking on the ad banner's designated virtual purchasing button, for example.

Advertisers and other services providers often try to achieve direct communication with the user by allowing, for example, to enter his/her communication details such as phone number—for communicating with the user by calling him/her, email address for sending advertising emails, internet protocol (IP) address for communicating with the user through online call services and protocols such as voice over IP (VoIP) etc.

Ad banners with calling tools are also provided enabling the user to click a designated area in the banner in order to initiate a call (such as a VoIP call) between the advertiser and the user.

Patent Application No. US2007100956 (A1) (referred to hereinafter as “the Application”), provides system and method for more telephone call based pay-for-performance Internet advertising. This Application allows callers to connect to advertisers over the telephone by just a single click from a generally distributed Internet-based advertisement, by providing the capability to efficiently track precisely from which channel, of a multiplicity of Internet-based distribution channels, a unique advertiser's advertisement attracted an incoming call, and by providing a simple set pricing structure for advertisers and a complex, behind-the-scenes, combination of category, keyword, random selection and historical experience for priority display of advertisements (see Application US2007100956 (A1), Abstract).

The Application enables facilitating the creation of a unique batch of computer code, a ‘single-click’ call activator link, for the advertiser that is embedded into the advertiser's unique Advertisement (see Application US2007100956 (A1), paragraph [0061]).

The Application enables creating an advertisement page (such as a network page) with an added calling link, which enables the activation of calls to the user.

### BRIEF SUMMARY

The present invention, in some embodiments thereof, provides a system, a method and a module for creating enhanced banners by integrating at least one original ad banner, which is a rich media file (RMF) with a calling application.

According to some embodiments of the invention, the system, module and method may enable integrating the original code of the original banner, comprising media content of one or more types and may also comprise code related to functionality of the ad banner (e.g. commands), with a code of the calling application and other graphical and operative functions (e.g. dialing function, client data storage, supervising code for supervising the created enhanced ad banner with the calling applicability, etc.); and creating an enhanced banner, which may be a new RMF, enabling the combined operative functioning of the calling application and the banner such as the graphical and operational aspects of the banner and the initiation and execution of calls between the user and the advertiser (e.g. through VOW applicability, calls between telephones (cellular or wired) of the advertiser and user and the like.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a flowchart schematically illustrating a method for integration an ad banner with at least one calling application, according to some embodiments of the invention;

FIG. 2 is a block diagram, schematically illustrating a system for creating combined rich media files enabling to integrate an ad banner with a calling application, according to some embodiments of the invention;

FIG. 3A is a diagram, schematically illustrating an integration module enabling to integrate content of an original banner with a calling application and a supervision code, using a dynamic container, according to some embodiments of the invention;

FIG. 3B if a flowchart, schematically illustrating a method enabling to integrate content of an original banner with a calling application and a supervision code, using the dynamic container, according to embodiments of FIG. 3A;

FIG. 4 is a flowchart, schematically illustrating a process in which the original code of an original ad banner is integrated with a calling application code by de-compilation the code of the original banner and recompiling the integrated codes, according to some embodiments of the invention;

FIG. 5A is a diagram, schematically illustrating an integration module for integrating the original banner as an embedded slave in a master container, according to some embodiments of the invention;

FIG. 5B is a flowchart, schematically illustrating a process for integrating the original ad banner as an embedded slave in a master container, according to embodiments of

FIG. 6 is a flowchart schematically illustrating a process of customizing and adding a calling functionality to an ad banner utilizing a plug-in software and an advertiser account, according to some embodiments of the invention; and

FIG. 7 is a diagram, schematically illustrating a main banners module, enabling to receive multiple original banners from multiple third and first party entities, integrate them with a calling application and return a resulting enhanced banners, according to some embodiments of the invention.

FIG. 8 is a flowchart schematically illustrating a process of Integrating an original compiled binary banner with a calling application and a supervision code, embedded as slave using a master container, according to some embodiments of the invention.

FIG. 9 is a flowchart schematically illustrating a process of loading an original compiled binary banner file to server's memory, according to some embodiments of the invention.

FIG. 10 is a flowchart schematically illustrating Preparation of supervision code, according to some embodiments of the invention;

FIG. 11 is a flowchart schematically illustrating Preparation of the SWF Container, according to some embodiments of the invention;

FIG. 12 is a flowchart schematically illustrating Preparation of Configuration SWF, according to some embodiments of the invention;

FIG. 13 is a flowchart schematically illustrating Injection of supervision code into original SWF, according to some embodiments of the invention;

FIG. 14 is a flowchart schematically illustrating Insertion of Modified original SWF to Container SWF, according to some embodiments of the invention;

FIG. 15 is a flowchart schematically illustrating the Insertion process of the Configuration SWF to Container SWF, according to some embodiments of the invention;

FIG. 16 is a diagram schematically illustrating the Modified original SWF Stack-based Representation, according to some embodiments of the invention;

FIG. 17 is a diagram schematically illustrating SWF Container structure after the Modified original SWF was inserted, according to some embodiments of the invention;

FIG. 18 is a diagram schematically illustrating SWF Container structure after Configuration SWF was inserted in which configuration parameters were set according to some embodiments of the invention;

FIG. 19 is a flowchart schematically illustrating the Embedding of a Button ID (or any other configuration parameter) in the Configuration SWF, according to some embodiments of the invention.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTION

The present invention, in some embodiments thereof, discloses a system 1000, a main banners module and a method for integrating the code of a rich media files (RMF) such as an advertisement banner (an ad banner) with a calling application, where each the banner is associated with at least one advertiser.

According to some embodiments of the invention, the integration may create a new rich media file (e.g. a new enhanced banner) comprising at least parts of the original banner, a “calling-code” enabling calling applicability and functionality and a “supervision code” allowing the new output file (the enhanced banner) to supervise and control the content of the new enhanced banner originating from the content of the original banner and the way the original code of the original banner is combined into the enhanced banner.

According to some embodiments of the invention, the resulting new enhanced banner may be a “ready-to-be-published” banner, where the new enhanced banner may enable all the operational, graphical and display features of the original banner with the additional functionality and display features enabling a user, inter alia to execute calls between the advertiser and the user through the new enhanced banner by, for example, clicking or double clicking a virtual calling button in a virtual bubble or a virtual folded corner whereby a call is executed automatically communicating the advertiser with the user (e.g. on the expense of the advertiser).

According to some embodiments of the invention, the calling application added to the advertiser's original banner may enable advertiser to communicate with users through (i) various communication networks, (ii) various formats, (iii) various users' terminal devices (e.g. PC, laptops, mobile phones, phones etc.) and (iv) various communication protocols (e.g. VoIP communication, wireless communication, public switch telephone network (PSTN), etc.).

According to some embodiments of the invention, the calling application may initiate an automatic callback option whereby a communication system initiates a call back to the user's terminal (e.g. to through the terminal's phone number, SIP or IP address) and connect the call with advertiser. For example, the converted new enhanced banner may display a bubble in the display area (stage) of the enhanced banner with input fields that should be filled by the user enabling the user to input communication and personal input such as the user's phone number, IP address or any other communication identifier. As the user selects the call (e.g. by clicking upon a virtual button) a communication system may automatically initiate call both to the advertiser's communication terminal and to the user's terminal (e.g. via VoIP or via a wireless/wired communication) and then connect the call as known in the art.

According to some embodiments of the invention, a predefined program code embedded in the new RMF (which may be a new output banner with the calling application) may enable supervising, controlling and managing the display and operative functionality of said new RMF enhanced banner features. The graphical and operative functionality of the new RMF may include the managing of the original banner's media content and interface operations as well as execution of calls through the new RMF.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

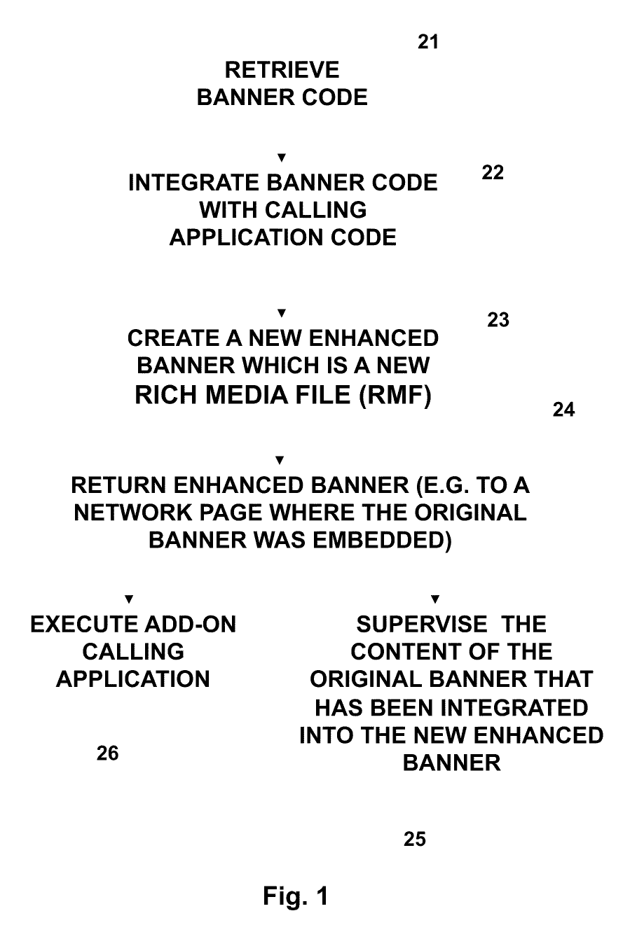

FIG. 1 is a flowchart, schematically illustrating a method for integration and supervision of an original ad banner 10′ with at least one calling application, according to some embodiments of the invention. The method may comprise:

retrieving the original code of the original ad banner 21 (e.g. through a main website);

integrating the original code of the original banner 10′ (e.g. content and scripts) with a calling application 22 and other graphical and operative functions;

creating a new RMF, which is a new enhanced banner 23 enabling the combined operative functioning of the calling application, the original banner 10′ and other functions, where steps 22 and 23 provide the conversion of the original banner 10′ into a new enhanced banner 10 RMF;

embedding the newly created. RMF in at least one network page 24;

supervising and controlling the original banner content and code 25 in parallel to executing the newly added calling application 26 in the newly created output file, where the system 1000 may allow operating the new file as a new banner added with the calling applicability; and

executing a call between the user and the advertiser according to predefined execution settings, whenever the user initiates a call using a calling interface of the calling application integrated in the enhanced banner 10.

According to some embodiments of the invention, retrieving banner code may include uploading the original banner 10′ through the a network such as the internet to the system 1000 and, embedding the new RMF enhanced banner 10 in a network page 50 may include downloading the enhanced banner 10 RMF through the network from the system 1000 prior to embedding it in the network page 50. According to some embodiments of the invention, the calling application may allow executing calls to establish communication between a users' terminals such as, for example, personal computers (PCs), laptops, cellular phones etc., as known in the art, through any type of communication network, including but not limited to network known in the art such as, for example, the Internet, intranet, wireless communication networks etc. as known in the art.

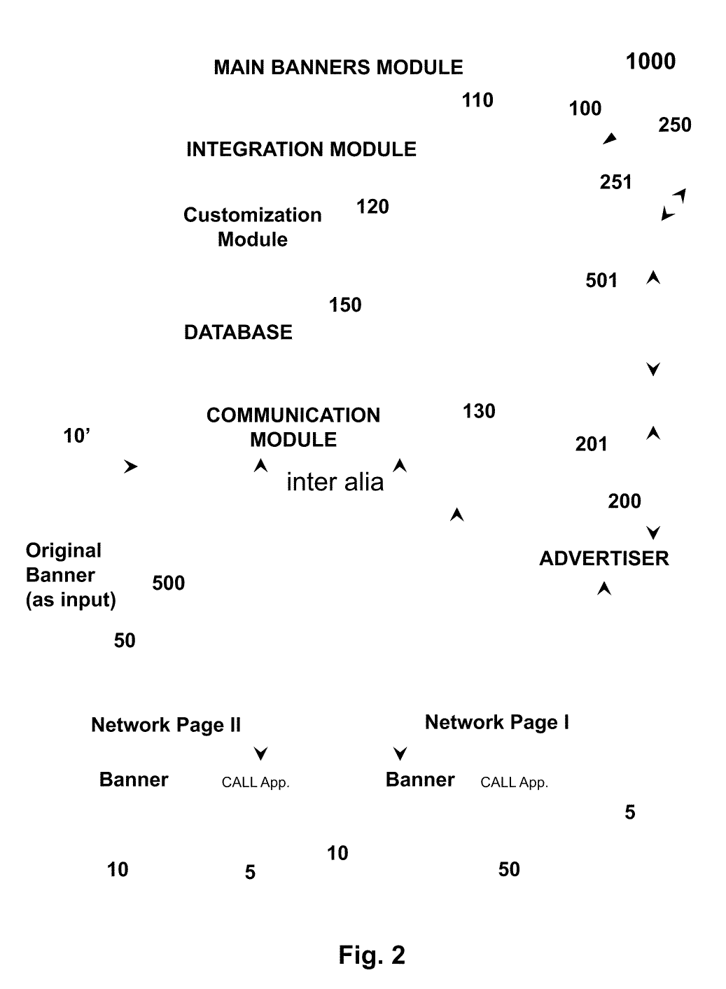

FIG. 2 schematically illustrates the system 1000 for creating combined rich media files enabling to integrate an original ad banner 10′ application with a calling application 5, according to some embodiments of the invention.

According to these embodiments, the system 1000 may comprise at least one advertiser's terminal 201, which may be any communication and/or computerized device, associated with an advertiser 200; at least one user's terminal 251, which may be one or more communication and/or computerized device associated with at least one user 250; a main banners module 100 and one or more network pages 50.

According to embodiments, the main banners module 100 may enable integrating the original banners 10′ with the calling applications 5 as well as with a supervision code enabling to supervise over the code of the original banner 10′ and the way the original code of the original banner is combined into the enhanced banner.

According to embodiments, as illustrated in FIG. 2, the main banners module 100 may comprise at least some of:
an integration module 110 enabling to receive the code of the original banner and integrate it with a calling application code creating a new RMF enhanced banner comprising the combined operational functionalities and content of the original banner and the calling applicability;
a customization module 120, which may include a user interface enabling the advertiser 200 and other users to customize the calling application 5 of their enhanced banners 10 (e.g. by inputting calling identifier(s) such as the advertiser's 200 phone number(s), IP address for VoIP communication etc, defining graphical parameters of the calling application and functionality parameters and/or conditions of the calling application such as available calling hours and days of the week etc.).
a communication module 130 managing the communication of the new enhanced banner 10 with the system 1000, definitions (e.g. made by the advertiser 200 regarding the calling application) and recording (e.g. storing information of the calls executed and the network page 50 from which the execution is carried out, web redirections originated by the original banner content, the caller's IP address and phone number etc.), where communication may be initiated through any type of communication network, including 500 currently or future known in the art; and
at least one database 150 enabling to store and search for information regarding the original banners 10 of all registered advertisers 200 (e.g. calling application display definitions and calling definitions such as available calling hours, etc.), the advertisers' 200 other related details (e.g. name, payment details, etc.), pay per call related information (e.g. updated calling rates, number of click-calls performed for each new RMF of each advertiser etc.).

According to some embodiments of the invention, the communication between the advertiser's terminal 201 and the banners main integration module 100, the communication between the user's terminal 251 an the main banners module 100, and the communication between the banners 10 and the main banners module 100 may be carried out via or more communication networks 500, as illustrated in FIG. 2. For example, the advertiser 200 may enter an Internet website through the Internet network 500 to convert his banners 10′ into enhanced banners using a terminal 201 such as a PC, a laptop or any type of terminal known in the art enabling communication and processing of data.

The terminals 201 and 251 used for communicating the advertiser 200 with the user 250 through a call initiated by the calling application 5 may be different than the terminals 201 and 251 used for communicating with the main banners module 100 and the enhanced banners 10, respectively, using at least one different communication network 501, depending on the system's 1000 definitions and the terminal types available by the advertiser 200. for example, the advertiser 200 may define more than one communication networks and/or terminals 201 available for communicating with the user 250 (e.g. the internet—using VoIP, a wired communication network using a telephone, and/or wireless communication network using a cellular phone as the terminal 201).

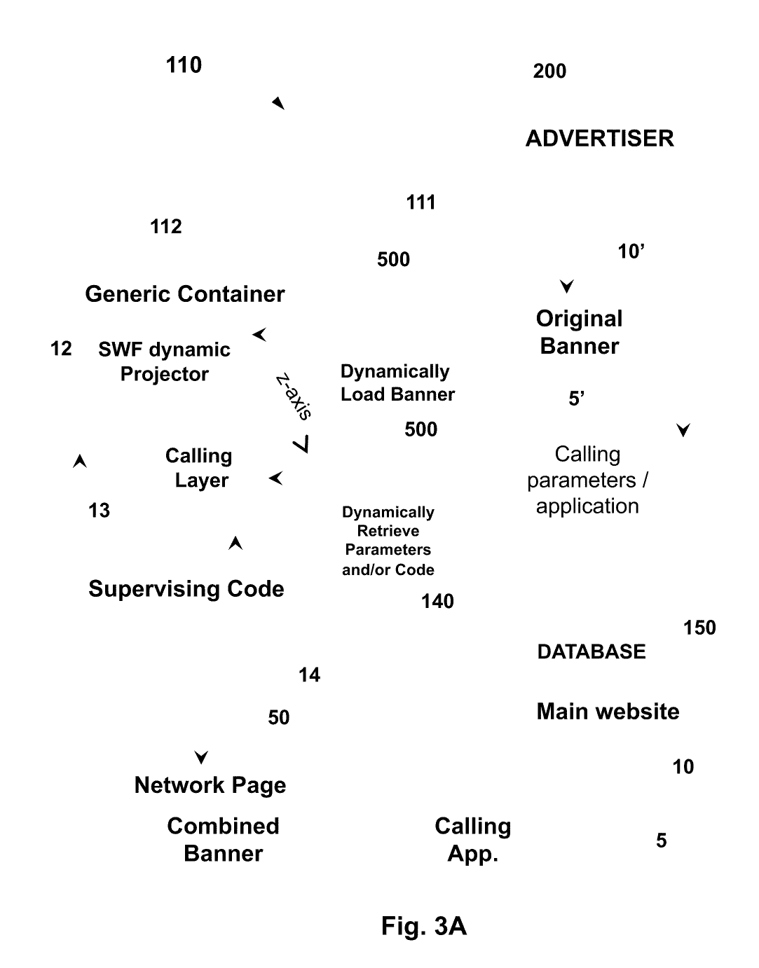

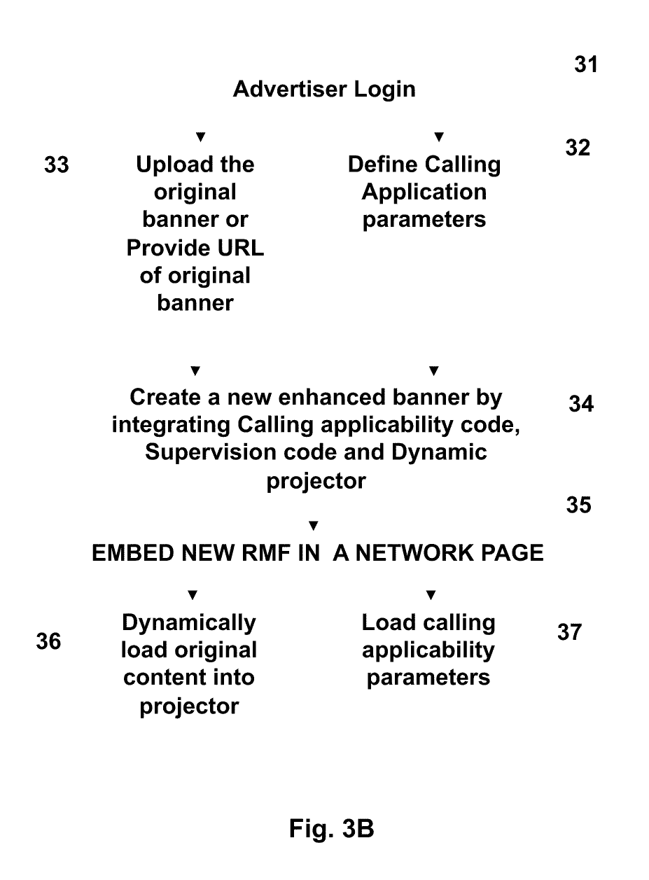

FIG. 3A is a diagram, schematically illustrating an integration module 110 enabling to integrate an original banner 10′ with a calling application code and a supervision code, using a dynamic container 112, according to some embodiments of the invention.

According to these embodiments, the integration module 110 may, make use a generic dynamic container 112, enabling to retrieve and to contain an original banner's code, content and data dynamically loaded from a network page (for example website 111); a website 111, enabling the advertiser 200, to create an enhanced banner 10 by providing content, definitions and code of the original banner 10′, which may be dynamically retrieved by the container 112 based on the provided URL address of the original banner 10′.

The dynamic generic container 112 may comprise a dynamic projector 12 (e.g. a shockwave (SWF) projector); a calling layer 13 (which may display and operate the calling application); and a supervision code 14.

The dynamic projector 12 may enable receiving the location (URL) of the original banner 10′, and some of the banner's 10′ code and projecting the content of the original banner 10′ onto the enhanced banner 10 when the enhanced banner 10 is published in at the network page 50.

The calling layer 13 may be a code for creating the calling application 5 enabling to receive input parameters from the advertiser 200 through the website 111 such as the advertiser's 200 calling details (e.g. phone number(s), IP address etc., graphical features of the interface of the calling application 5 and other calling parameters such as calling conditions). The calling layer 13 may enable dynamically projecting the calling applicability and/or parameters to the calling application 5 in the created enhanced banner 10. Optionally, the calling layer 13 may further enable loading the code of the calling application 5 itself.

FIG. 3B if a flowchart, schematically illustrating a method enabling to integrate code and content of an original banner with a calling application code and with a supervision code, using the dynamic container 112, according to embodiments of FIG. 3A.

According to these embodiments, the method may comprise:

logging into the main website 31

defining the parameters of the calling tool (e.g. carried out manually by the advertiser 200 by inputting the parameters through an interface in the website 111) 32;

Uploading the locator (e.g. URL) of the original banner 10′ and accessing the original banner's 10′ content and code or uploading the original banner 10′ file (e.g. to the website 111) 33;

Creating a new enhanced banner 34 through the container 112;

embedding the new enhanced banner 10 in at least one network page 35 (which may be carried out by an external software and user);

dynamically loading the content of the original banner 10′ from it stored location to the enhanced banner 36 (depending on step 33); while

dynamically loading the calling application and its retrieved parameters to the enhanced banner 37.

The advertiser 200 may register and login to the main website 111 enabling the conversion of original banners 10′ into calling enhanced banners 10. The registration may allow creating a personal account associated with the advertiser 200, where the account may be associated with at least one ID sequence (e.g. password and user name). Once the advertiser 200 enters the account, the advertiser 200 may (1) provide the original banner 10′ by upload or by providing its web location; (2) define the calling parameters or features of the calling application 14 through a designated interface predefined in the website 111, where the system 100 may execute a customization program allowing customizing the parameters of the calling application 14 that will be integrated with the banner 10 (e.g. time frame that the calling application appears, colors, fonts, sizes, defaults, etc). The new RMF enhanced banner 10 container generated may be embedded with a projector 12 which may load original content on-the-fly upon publishing of the enhanced banner 10 at the at least one network page 50 through the network 500. The calling layer 13 may draw and maintain the calling application 14 according to parameters defined by advertiser 200 and may be retrieved on-the-fly through network 500. The system 1000 may further integrate a supervising code 14 in the enhanced banner 10 that may allow managing the code of the original content or its projector 12, calling layer 13 or its placeholder and other related supervision codes (including original content redirections, communications, event handling, z-axis, etc).

In some embodiments of the invention, the enhanced container 10 may also dynamically load at least part of the calling application code 14 at run-time and then execute it to reduce the container file size at impression time at network page 50. Parts or all of the calling application code 13 loading may be done in the same way as the way the original content is loaded into the container 112 (in SWF files, for example, by loading a resource of a compiled SWF file into a movie clip object or sprite, utilizing its URL).

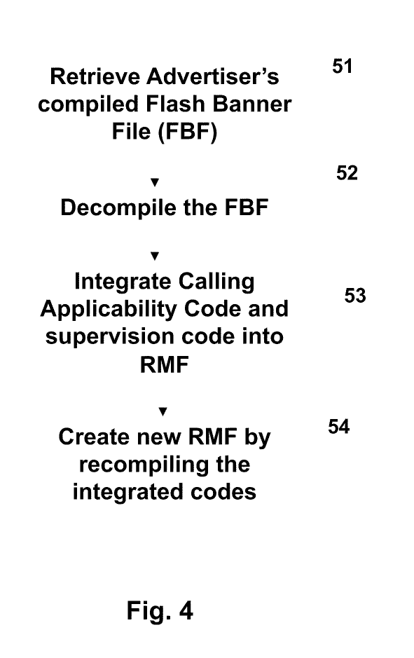

FIG. 4 is a flowchart, schematically illustrating a process by which the integration of the original code of the original banner 10′ may be integrated with a calling application code to create a new RMF enhanced banner 10, by decompiling the original banner and recompiling the integrated codes of the original banner and calling application, according to some embodiments of the invention. According to these embodiments, the process may comprise:
retrieving an original compiled banner 10′ file (e.g. Flash banner file) 51;
decompiling the banner file 52;
integrating the decompiled banner file with (i) the code of the calling application and (ii) with the code enabling to supervise the original content and calling content, display and other functional and operational features 53; recompiling the integrated codes 54, thereby creating a new rich media file.

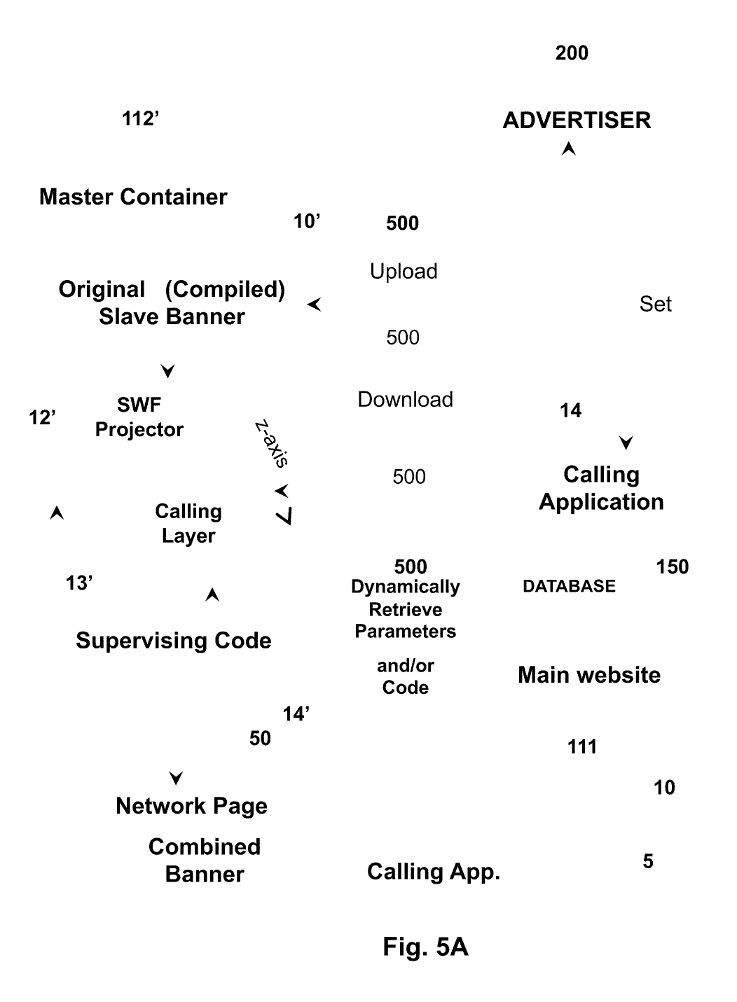

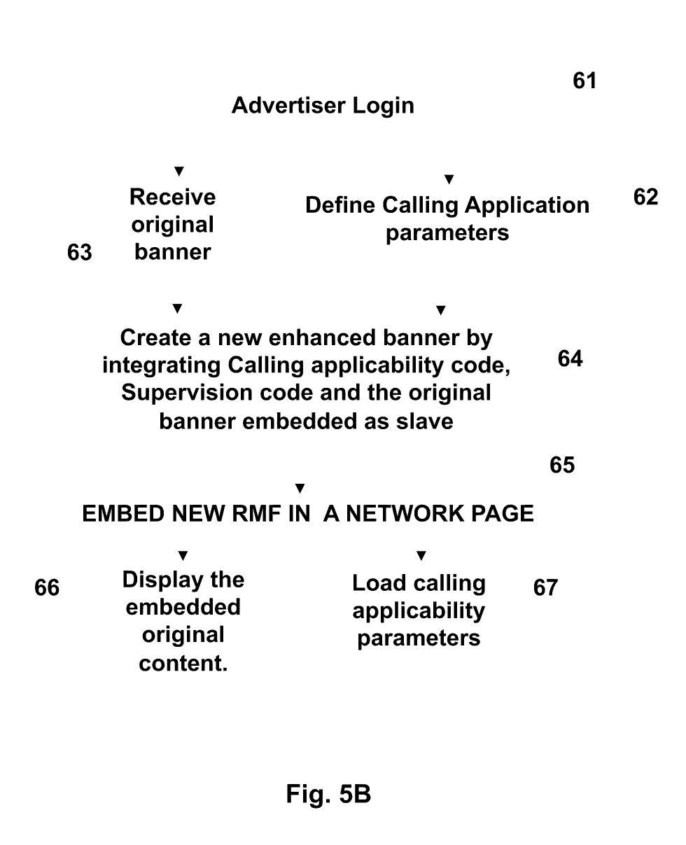

FIG. 5A is a diagram, schematically illustrating an integration module 110 for integrating the original banner 10′ as a slave in a master container 112′, according to other embodiments of the invention. According to these embodiments, the integration module 110 may enable embedding the advertiser's 200 original banner 10′ as a slave in a master container 112′. The master container 112′ may comprise a projector 12′, a call layer 13′ and, optionally, a supervision code 14′.

The projector 12′ may enable receiving the content and code of the original banner 10′ from within the master container 112′ and displaying the content of the original banner 10′ in the enhanced banner 10.

The calling layer 13′ may be a code for creating the calling application 5 enabling to receive input parameters from the advertiser 200 through the website 111 such as the advertiser's 200 calling details (e.g. phone number(s), IP address etc., graphical features of the interface of the calling application 5 and other calling parameters such as calling conditions). The calling layer 13′ may enable dynamically loading the parameters to the calling application 5 in the created enhanced banner 10.

The supervision code 14′ may enable supervising over the content of the original banner 10′.

Additionally, when the container banner 10 is published, the projector 12′ may load the original banner 10′ as an embedded resource of the file, wherein the calling layer 13′ may load its parameters as stored under the advertiser's 200 account in a database 150.

In some embodiments of the invention, the master container 112′ may dynamically load at least part of the calling application code 13′ at run-time and then execute it to reduce the master container file size at impression time at network page 50 (e.g. in SWF files, for example, by loading the calling application as a compiled SWF file into a movie clip object or sprite, utilizing its URL).

FIG. 5B if a flowchart, schematically illustrating a method enabling to integrate code and content of an original banner 10′ with a calling application code and a supervision code, using the master container 112′, according to other embodiments of FIG. 5A.

According to these embodiments, the method may comprise:

logging into the main website 61

defining the parameters of the calling tool (e.g. carried out manually by the advertiser 200 by inputting the parameters through an interface in the website 111) 62;

receiving and embedding the original banner 63 into the master container 112′;

creating a new enhanced banner 64 using a master container 112′;

embedding the new enhanced banner 10 in at least one network page 65 (where the embedding is carried out by an external application and/or distributor);

Displaying the content of the original banner 10′ 66 (which may include loading the content and code 10′ from the master container 112′); while

dynamically loading the calling application and/or its retrieved parameters to the enhanced banner 67.

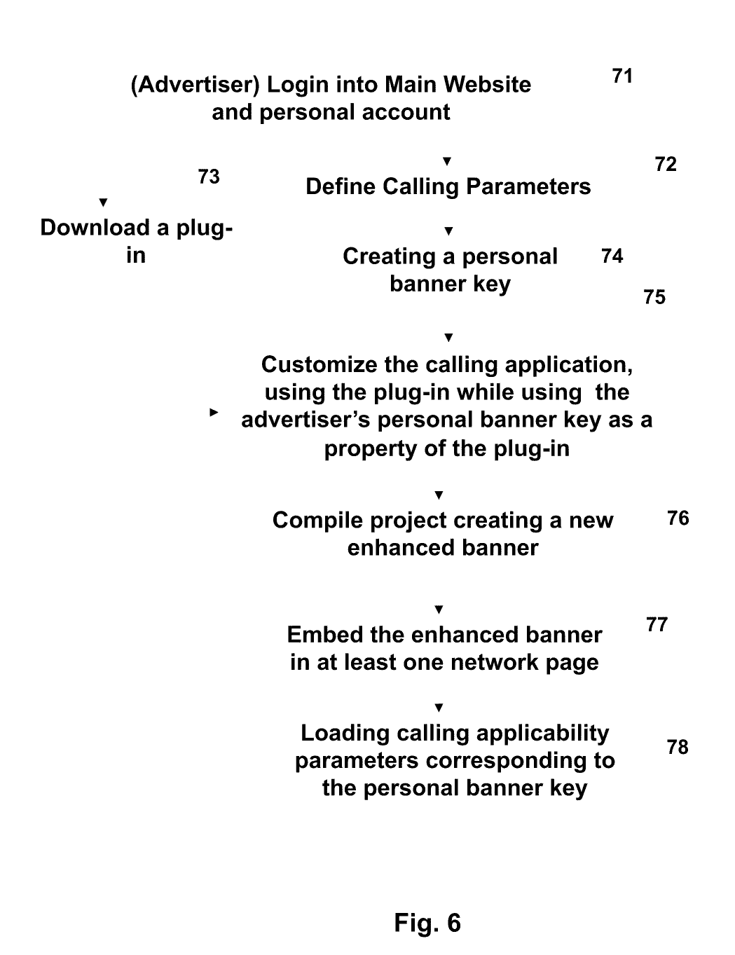

FIG. 6 is a flowchart, schematically illustrating a process for customizing the parameters and functionality of the calling application 5, according to some embodiments of the invention,

According to some embodiments of the invention, as illustrated in FIG. 6, the method for customizing the calling application 5 may comprise:

logging into the main website 111 and into a personal account of the advertiser 71 (where the advertiser 200 carries out the logging);

defining calling parameters 72;

downloading a plug-in software tool 73, enabling a user (such as a graphic designer) to customize the graphical designing and functionality of the calling application of the advertiser 200;

automatically creating a personal key enabling access to all the calling application parameters defined by the advertiser 200 74;

customizing the calling application of the advertiser 75, using the plug-in and providing the plug-in with the advertiser's 200 personal key property to define the properties of the calling application 5 of the advertiser 200;

compiling the project creating a new enhanced banner 76

embedding the enhanced banner 10 in at least one network page 77; and

loading the calling application parameters (originally defined by the advertiser 200) corresponding to the personal key of the advertiser 78.

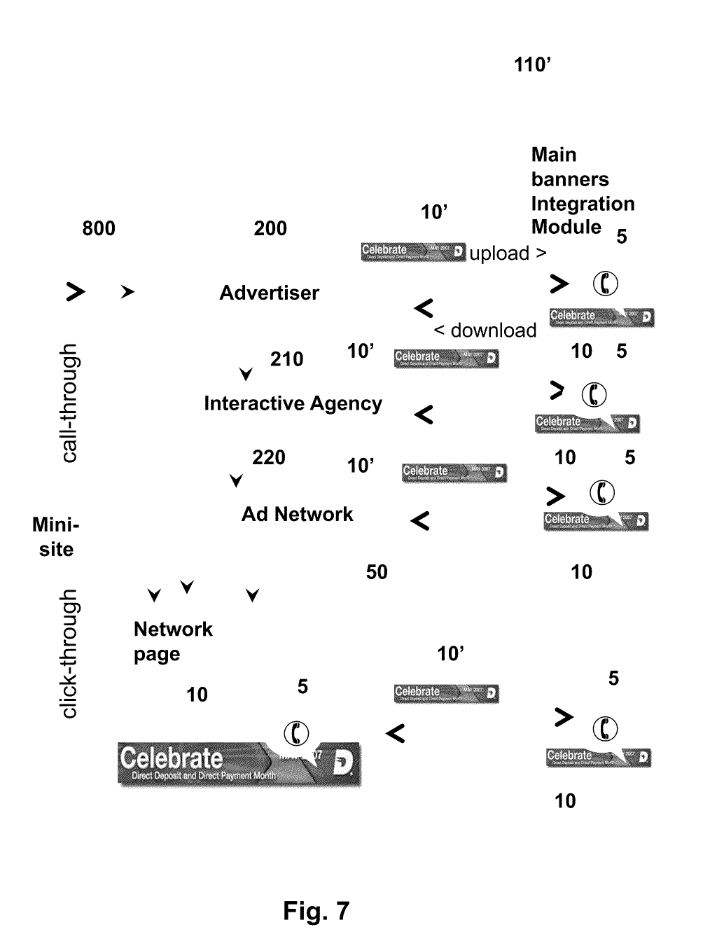

FIG. 7 is a diagram, schematically illustrating a main banners module 110′, enabling to receive multiple original banners 10′ from multiple sources such as the advertiser 200 (using the main website 111 for example, an interactive agency 210, an ad network 220 etc, which may be third party entities that can maintain banners of advertisers 200), integrate them with calling application 5 and return the resulting enhanced banners 10 to the entity that provided the original banner 10′ or sent it to be enhanced by the system 1000, according to some embodiments of the invention.

This may allow a business method enabling: receiving an existing original banner 10′ advertisement from an advertiser 200 or on his behalf (using third party entities such as 210 and/or 220);
integrating each original banner 10′ with a calling application 5 code and a supervision code (using the main banners module 110′);
returning each converted enhanced banner 10 to the advertiser and/or third party entity such as 210 and/or 220 allowing it to publish the enhanced banner 10 in other external websites (network page 50), which may be uninvolved with the integration process; and
generating calls through the enhanced banners 10 which may be in-parallel to the clicks through the banner.
(optionally redirecting to a mini-site in-parallel to the generating the call (e.g. mini-site 800 or other website).

The parameters of the application may be altered and customized either before and after the enhanced banner was compiled and also before (e.g. in the website 111) and after applying the plug-in and using the personal key that enables accessing the customized parameters when using the plug-in.

Additionally the process may comprise a registration process in which the advertiser 200 provides details to be saved in a database associated with the main banners module 110′ in order to facilitate the call execution and controlling process, including redirection destination phone number(s), a time-frame for each of the phone numbers, means of payment and so on. The outcome of this business process may be a ready-to-be-published enhanced banner 10 that resembles the original banner 10′, but with an added calling functionality 5. The new enhanced banner 10 may offer free calls to consumers' communication terminals or devices when the once the users select the calling function option. The new enhanced banner 10 may display an interface presentation of the calling application 5 (e.g. a call bubble within the banner) with a phone number field and a ‘Call’ button offering a free callback from the advertiser.

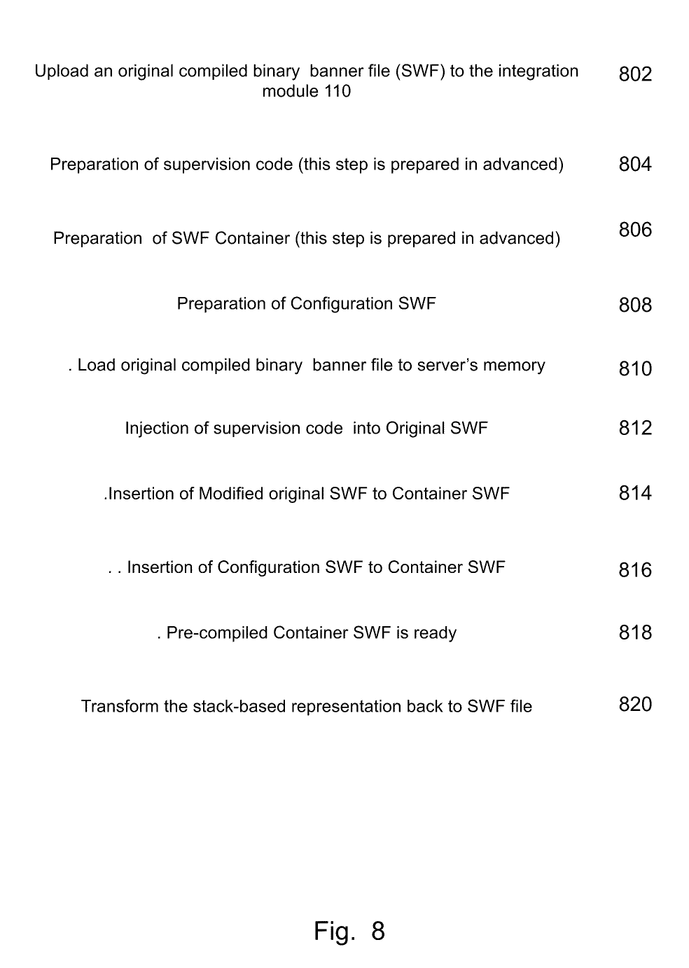

FIG. 8 is a flowchart schematically illustrating a process of Integrating an original ad banner with a calling application and a supervision code, embedded as slave using a master container, according to some embodiments of the invention. Before this process start are prepared in advance: the supervision code to be integrated in the original banner code (step 804), SWF Container (step 806) in which the original banner is integrated with calling application and Configuration SWF (step 806). The process starts with loading original compiled binary ad banner file to server's memory (step 810) as stack-based representation of Flash Tags and Actions. The prepared supervision code, is also transformed to the stack-based representation, is injected into original SWF stack-based structure (step 812). The supervision code purpose is for associating between the original banner's behavior and calling application response. The modified original SWF is inserted into Container SWF to be part of the enhanced banner (step 814). The updated Configuration SWF is inserted in the Container SWF (step 816). At this stage the pre-compiled Container SWF is ready (step 818) and is transformed from the presentation-stack format to SWF file format (step 820).

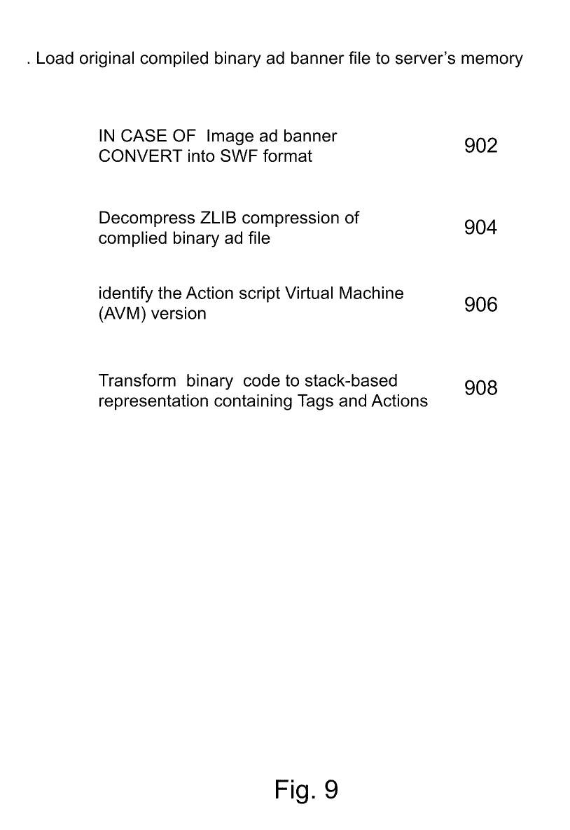

FIG. 9 is a flowchart schematically illustrating a process of loading an original compiled binary ad banner file to server's memory, according to some embodiments of the invention. The process of loading the original banner code, includes: converting an image banner (in case input banner file is not SWF) into SWF format (step 902), decompressing ZLIB compression of the complied binary SWF banner (step 904), identifying the ActionScript Virtual Machine (AVM) version to determine which version of the supervision code to use (by loading the SWF as bytes and parsing out the 4th byte to get the version number, the results of this can be AVM1 (ActionScript 1 or 2) or AVM2 (ActionScript 3) and transforming the binary code to stack-based representation (step 908) (Adobe (spec: http://www.adobe.com/content/dam/Adobe/en/devnet/swf/pdf/swf_file_format_sp ec_v10.pdf, including “Tags” and “Actions”.).

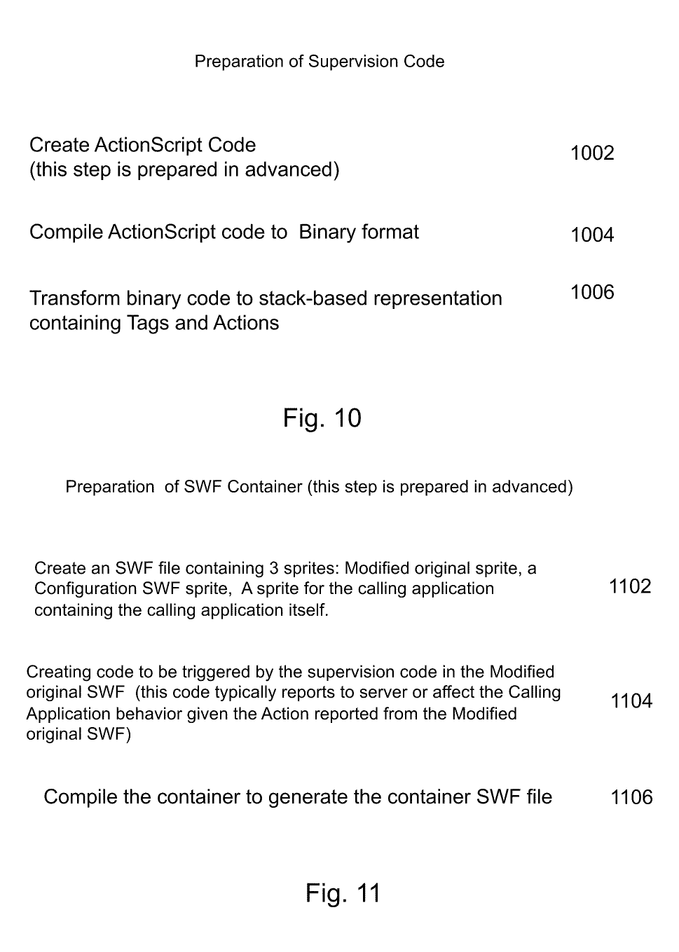

FIG. 10 is a flowchart schematically illustrating Preparation of supervision code, according to some embodiments of the invention. The supervision ActionScript code is created in advance in two versions ActionScript2 and ActionScript3 code (step 1002), compiled to binary code format (step 1004) and transformed to stack based presentation (step 1006) to enable the integration with original banner code.

FIG. 11 is a flowchart schematically illustrating Preparation of the SWF Container, according to some embodiments of the invention. The SWF Container is prepared in advance in two versions: ActionScript2 and ActionScript3, to include three sprites: Modified original SWF sprite, a Configuration SWF sprite and A sprite for the calling application (step 1102) containing the calling application itself. A designated code is created in the SWF Container to be triggered by the supervision code in the Modified original SWF. This code typically reports to server or affect the Calling Application behavior based on reported Actions from the Modified original SWF (step 1104). At the last step the container is complied to generate the Container SWF binary file (step 1106).

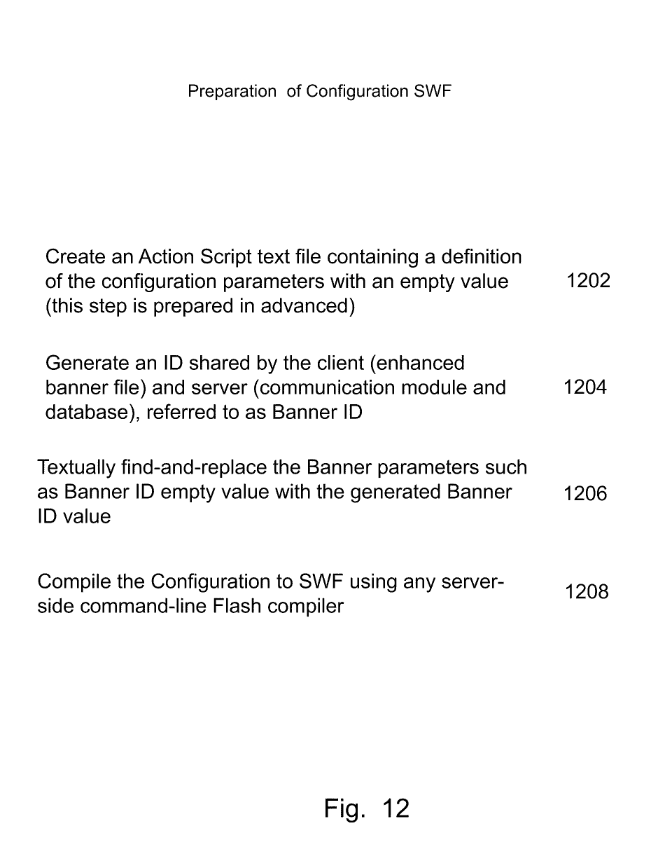

FIG. 12 is a flowchart schematically illustrating Preparation of Configuration SWF, according to some embodiments of the invention. The preparation is preformed in advance by creating an ActionScript text file containing a definition of the configuration parameters with an empty value (step 1202), generating an ID shared by the client (enhanced banner file) and server (communication module and database), referred to as Banner ID (step 1204), while the enhanced banner is created: locating the banner's parameters such as Banner ID empty value and using a simple textual find-and-replace, replacing this parameter(s) value (such as Banner ID) with the generated Banner ID value (step 1206), and compiling the Configuration to SWF using any server-side command-line Flash compiler (step 1208).

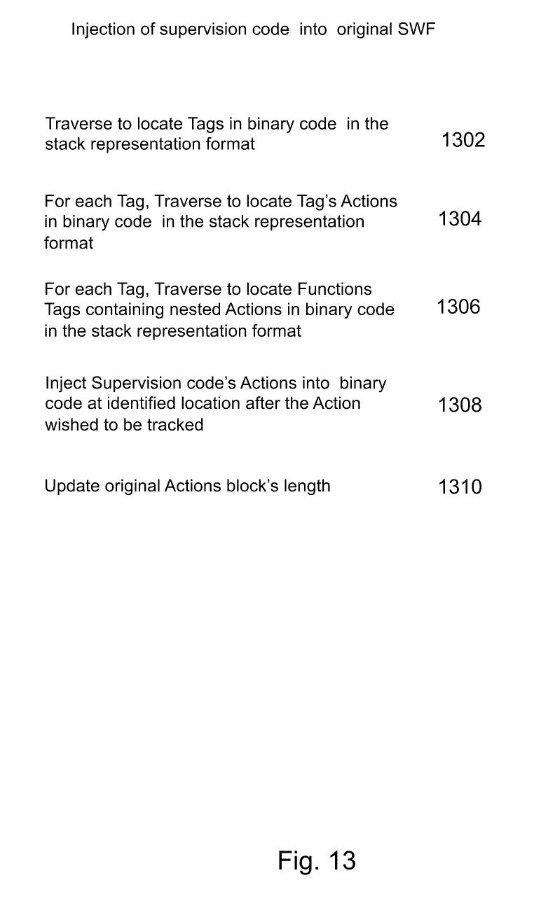

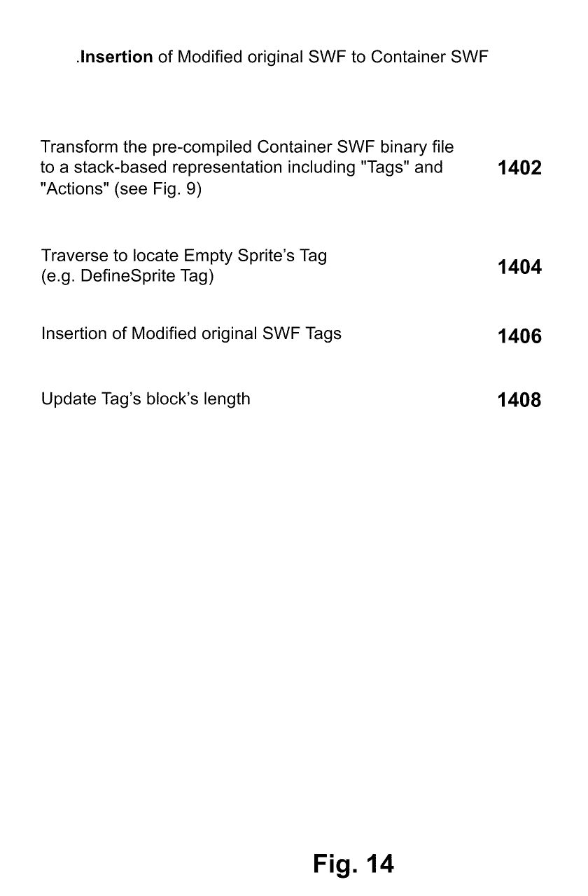

FIG. 13 is a flowchart schematically illustrating Injection process of supervision code into original SWF, according to some embodiments of the invention. The injection process includes traversing the binary code in the stack representation format to locate Tags (1302), for each Tag traversing binary code in the stack representation format to locate Tag's Actions (1304) and nested Functions containing Actions (step 1306), by traversing binary code in the stack representation format to track for.

Based on this traversing analysis, the supervision code Actions are injected into binary code at identified location of relevant Action (step 1308). At the last step original Actions block's length is updated (step 1310) according to the number of Actions added.

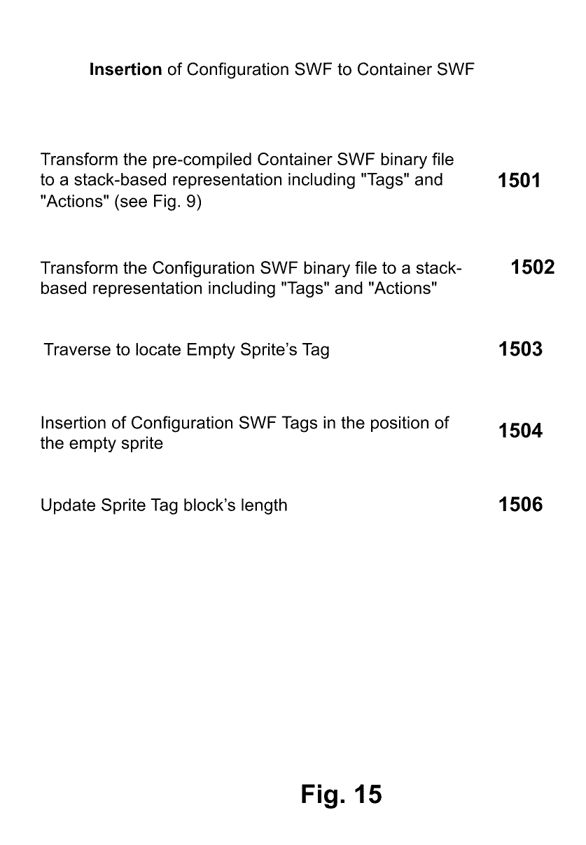

FIG. 14 is a flowchart schematically illustrating Insertion of Modified original SWF to Container SWF, according to some embodiments of the invention. This insertion process includes traversing the Container stack-based representation (1402), prepared in FIG. 9, for empty Sprite entry (1404), insertion of the Modified original SWF Tags under this Sprite (1406) and updating the Sprite Tag's length according to the length of the Tags added (1408).

FIG. 15 is a flowchart schematically illustrating the Insertion process of Configuration SWF to Container SWF, according to some embodiments of the invention. The insertion process includes the steps of: Transforming the pre-compiled Container SWF binary file to a stack-based representation including Tags, Actions and Functions (step 1501), transforming the Configuration SWF to same format (1502), locating within the Container's stack-based representation empty Sprite Tag corresponding to predefined name (step 1503) and inserting the Configuration SWF representation in the position of the empty sprite (step 1504). At the last step this Sprite Tag's length (1408) is updated according to the newly inserted Tags.

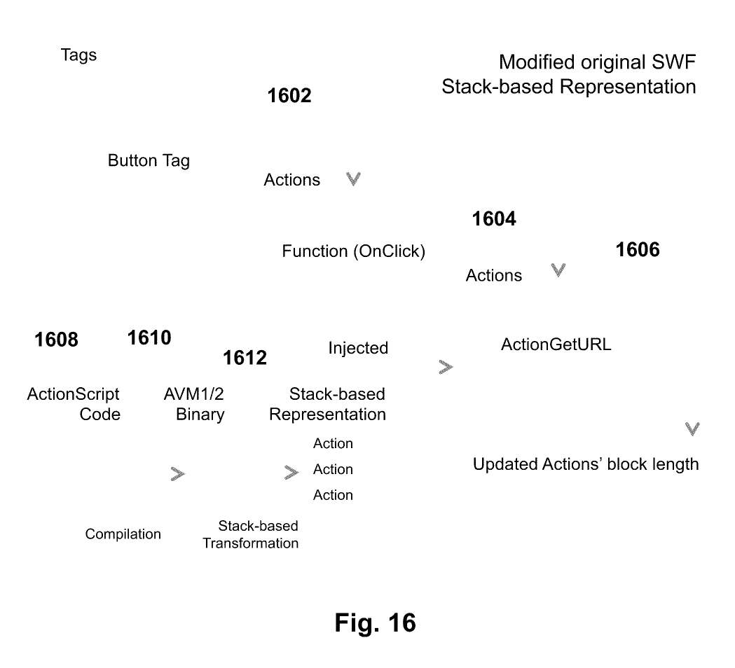

FIG. 16 is a diagram schematically illustrating the Modified original SWF Stack-based Representation according to some embodiments of the invention. The Stack-based Representation include Tags (1602) which include definitions, Actions (1604), Functions containing nested Actions (1606). In this example, the supervision code (1612) is installed to notify the Container SWF once a new window is opened as a result of pressing a button in original SWF. Therefore the supervision code was injected right after the ActionGetURL Action (1606) in the OnClick Function (1604) of the Button Tag (1602). The supervision code, started as an ActionScript code (1608) is complied to binary format (1610), and transformed to stacked based representation (1612) adapted to be inserted to the proper location in original code of the banner.

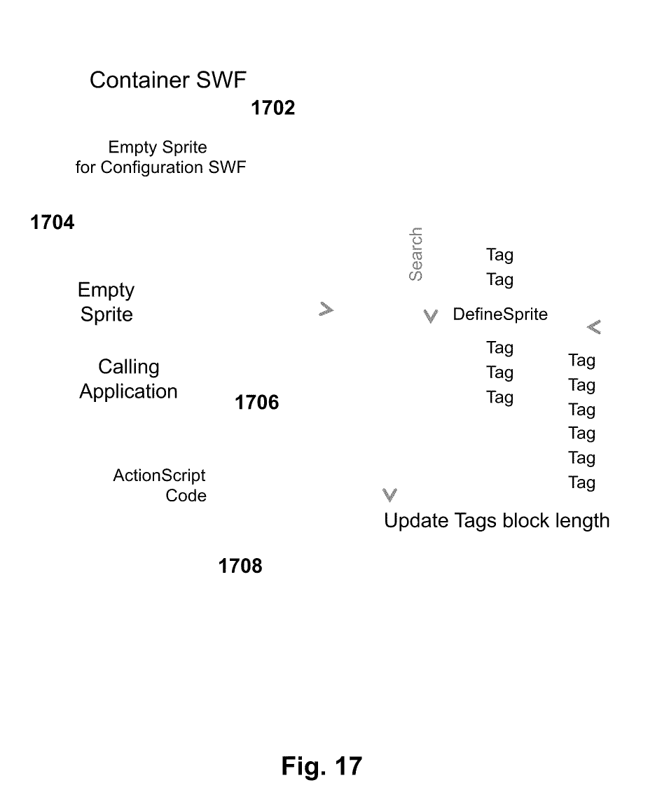

FIG. 17 is a diagram schematically illustrating SWF Container structure after the Modified original SWF was inserted to it, according to some embodiments of the invention. The SWF Container is comprised of Empty Sprite for Configuration SWF (1702), empty Sprite (1704) for the modified code of the original banner, the calling application itself (1706) and the ActionScript code (1708) to be executed once the supervision code in the Modified original SWF reports to the Container, for controlling the operation of the enhanced banner. This code can control the calling application (since this code is native in the Container), or typically reports to server about this Action.

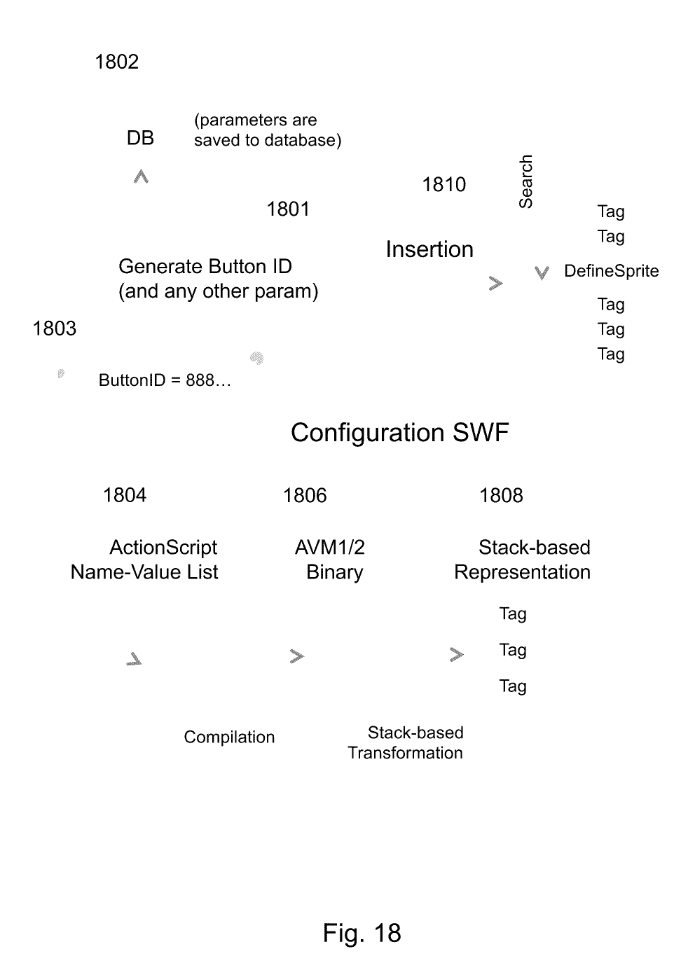

FIG. 18 is a diagram schematically illustrating SWF Container structure after Configuration SWF was inserted, in which configuration parameters were set (such as Banner ID), according to some embodiments of the invention. This illustration exemplifies the generation and insertion of the Configuration SWF: for each original banner identifying parameter such as a Button ID is generated (1801) and is saved to the database (1802). The Configuration SWF inserted (1810) to the Container SWF is made by compiling (1806) an ActionScript code containing name-value pairs (1804), after replacing empty values (1803) with the value generated in server. The Tags of the Configuration SWF are now part of the Container SWF as it were inserted as content of the empty Sprite Tag (e.g. DefineSprite) at 1810. The source ActionScript (1804) version and compiler used at 1806 should match the original SWF AVM version detected (906 at FIG. 9): ActionScript2 code and AVM1 compiler, or alternatively ActionScript3 code and AVM2 compiler.

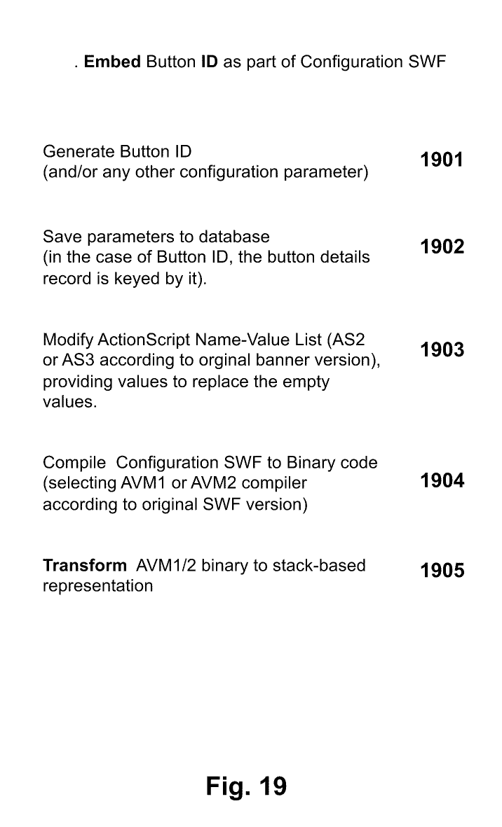

FIG. 19 is a flowchart schematically illustrating the Embedding of a Button ID (or any other configuration parameter) in the Configuration SWF, according to some embodiments of the invention. The process of preparing the Configuration SWF to insertion in Container SWF comprise of the following steps: A Button ID (or other parameter) is generated at server (1901) and saved to database. The Button ID may serve as a key for other banner related information, A textual find-and-replace is used to replace empty parameter value(s) in the Configuration source code (AS2/3 according to original SWF version), the Configuration is then compiled (AVM1/2 according to original SWF version) and transformed from binary to stack-based representation

According to some embodiments of the invention is suggested a method of enhancing an original SWF banner file with a calling application, without code sources and without de-compilation to sources. The method includes the following steps:
1. Uploading an original compiled binary ad banner file, which is a compiled rich-media file (SWF) to the integration module.
2. Loading Original compiled binary ad banner file to server memory (of integration module), the loading supports, images by converting the image into a compiled binary ad banner file (using any server-side software). After loading, the following process are performed:
   a. De-compressing the Compiled binary ad files which are compressed using ZLIB compression.
   b. Identifying the ActionScript Virtual Machine (AVM) version by loading the SWF as bytes and parsing out the 4th byte to get the version number. The version can be AVM1 (ActionScript 1 or 2) or AVM2 (ActionScript 3).
   c. Transforming the binary file to a stack-based representation according to the AVM1 or AVM2 specification by Adobe (spec: http://www.adobe.com/content/dam/Adobe/en/devnet/swf/pdf/swf_file_format_sp ec_v10.pdf), including “Tags” and “Actions”.
3. Injection of supervision code, including the following process
   a. Traversing the stack-based representation to locate Tags which represent an action to track. For example, locate “Button” tags.
   b. For each Tag found,
      i. Traversing list of associate Actions to find Actions to be supervised, such as “ActionGetURL” (which opens a new window and can be tracked as user's click-through action).
      ii. Traversing Function entities, each containing associate Actions, as in (i).
   c. Inserting the supervision code, which is prepared in advanced according to the following steps:
      The ActionScript code is enabled to report to the Container SWF about the Action being tracked, optionally providing Action parameters. This code typically uses a reference to a function located in the container's root (direct approach), or triggers an event caught by the Container SWF using LocalConnection (event-driven approach). The ActionScript code is compiled to SWF (AVM1 or AVM2) and the
      compiled code is transformed to Actions, based on same stack-based representation generated from the original compiled binary ad banner file.
d. Updating this Tag's length to account for the new injected code.

The outcome of this injection is referred as the “Modified original SWF”.
4. Creation of the Container SWF (these steps are prepared in advanced):
   a. Creating an SWF file containing 3 sprites:
      i. An empty sprite with a predefined name (to be replaced with the Modified original SWF).
      ii. An empty sprite with a predefined name (to be replaced with a Configuration SWF).
      iii. The Calling Application, coded in ActionScript, in a sprite located on top of the empty sprite.
      iv. The container should also contain a code to be triggered once the supervision code in the Modified original SWF file reports for supervised Actions (see 3.c). This code typically reports to server or affect the Calling Application behavior given the Action reported from the Modified original SWF.
      b. Compiling the container to generate the Container SWF file (using an AVM1 or AVM2 Container version according to original SWF version and also compiling with AVM1/2 compiler according to original SWF AVM version).

The created container will be referenced from now on as “Pre-compiled Container SWF file”.
5. Combine the Modified original SWF with the Pre-compiled Container SWF file:
   a. Transforming the pre-compiled Container SWF binary file into a stack-based representation including “Tags” and “Actions” (as done with the original ad in 2.c above).
   b. Traversing the stack-based representation to locate the “DefineSprite” Tag defining the empty sprite to populate with the Modified original SWF.
   c. Inserting the Modified original SWF representation in the position of the empty sprite.
   d. Updating this sprite Tag's length to account for the newly inserted code.
6. Creation of the Configuration SWF: In order to embed a Banner ID for the Calling Application, or provide any other predefined parameters which are available to the Calling Application prior to any communication with the server (communication module), a Configuration SWF is created to be integrated with the Pre-compiled Container SWF, using the following steps:
   a. Creating an ActionScript text file containing a definition of the configuration parameters with an empty value (this step is prepared in advanced).
   b. Generating an ID shared by the client (enhanced banner file) and server (communication module and database), referred to as Banner ID.
   c. replacing the Banner ID empty value with the generated Banner ID value.
   d. Repeating the last step for any other parameter, if required,
   e. Compiling the Configuration SWF using any server-side command-line Flash compiler.
7. Combining the Configuration SWF with the Configuration SWF file:
   a. Traversing the pre-compiled Container SWF stack-based representation to locate the “DefineSprite” Tag defining the empty sprite to populate with the Configuration SWF.
   b. Inserting the Configuration SWF representation in the position of the empty sprite.
   c. Updating this sprite Tag's length to account for the newly inserted code.
8. Transform the stack-based representation back to SWF file. This concludes the creation of the compiled enhanced rich-media banner file, enabling the combined operative functioning and content of the calling application and original ad, having bidirectional functionality with server. Prepared without original SWF code sources and without de-compilation to sources.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A computer implemented method of creating compiled enhanced rich-media banner files, each comprising content and functionality of an original compiled ad banner file, which is a compiled rich-media file, associated therewith and a calling application enabling users to initiate a call with an advertiser, wherein said advertiser is associated with the original and enhanced rich-media banner files,
said method comprising:
integrating the compiled original code and content of said original compiled ad banner with a code of the calling application; and
creating a new compiled enhanced rich-media banner file, enabling the combined operative functioning and content of the calling application having bidirectional functionality communication with the server and the compiled new banners, said creating of new complied enhanced rich-media banner file includes automatically changing or replacing the compiled original code not requiring compilation or recompilation of the banner original code, (not requiring the non complied source original code of original banner.
wherein the calling application can be controlled from remote sever based on calling application bidirectional functionality.
wherein the new created enhanced and compiled rich-media banner file enables a user to initiate a call between the advertiser and the user by operating the calling application in the enhanced rich-media banner file,
not requiring de-compilation or recompilation

2. The method of claim 1, further comprising embedding a supervision code at the complied level of the original banner such that the supervision code enables supervising over the code of the original ad banner and the way the compiled code of original banner is executed by the enhanced rich-media banner file, thereby operatively combining the functioning of the call application with the execution of the original banner.

3. The method of claim 1, wherein integrating of the code of the original banner with the code of the calling application includes decompiling of the code of the original banner, integrating the calling application code with the code and content of the original banner, and then recompiling the integrated codes to create the compiled enhanced rich-media banner file.

4. The method of claim 1, further comprising:
defining calling application parameters, enabling the advertiser to customize the calling tool after the banner has already been published;
uploading the compiled original banner to a dynamic projector operated in a dynamic container;
creating the enhanced rich-media banner file by integrating the calling application code, using a calling layer, enabling to dynamically load data and commands related to the calling application to the enhanced rich-media banner file with a dynamic projector, enabling to dynamically load the complied original banner into the enhanced rich-media banner file.
embedding the created enhanced rich-media banner file in at least one network page;
dynamically loading the complied original banner into the enhanced rich-media banner file, using the dynamic projector; and
dynamically loading the parameters of the calling application into the enhanced rich-media banner file, using the calling layer.
wherein all the operations relating the original banner do not require the source original code of original banner. The method of claim 4, further comprising logging into a main website, wherein the main website includes an interface enabling the advertiser to provide the original banner and define the parameters of the calling application, wherein the website is operatively associated with the dynamic container.

5. The method of claim 4, wherein the creation of the enhanced rich-media banner file further includes integrating a supervision code, which is included in the dynamic container, into the enhanced rich-media banner file, wherein the supervision code enables supervising over the code of the original banner and the way the original code of the original banner is executed by the enhanced rich-media banner file.

6. The method of claim 4, wherein the creation of the enhanced rich-media banner file further includes embedding a supervision code at the complied level of the original banner such that the supervision code enables supervising over the compiled code of the original salve banner and the way the original code of the original slave banner is executed by the enhanced rich-media banner file.

7. A main banners module of creating enhanced compiled rich-media banner files, each comprising content and functionality of an original ad banner file, which is a compiled rich-media file, and a calling application enabling users to initiate a call with an advertiser, associated with the original and enhanced rich-media banner files, said main banners module comprising an integration module enabling to receive the code and content of an original compiled banner and integrate the original banner with a calling application to create a new enhanced rich-media banner file with calling applicability, wherein said module is running on a computer server.

8. The main banners module of claim 7, further comprising:
a customization module enabling the advertiser users to customize the calling application of enhanced rich-media banner files;
a communication module enabling online communication with at least one enhanced rich-media banner file for managing the functionality and content of the enhanced rich-media banner file;
a database enabling to store data and search for information regarding at least one of: the location of the original banner; parameters defining the functionality of the calling application of the enhanced rich-media banner file associated therewith, data relating to the advertiser.
wherein the customization further includes enabling the advertiser to input at least one calling identifier, to define graphical parameters of the calling application and to define functionality parameters and conditions of the calling application.

9. The main banners module of claim 7, wherein the dynamic container further comprises a supervision code at the complied level of the original banner where the supervision code enables supervising over the compiled code of the original banner and the way the compiled code of original banner is executed by the enhanced rich-media banner file, there by operatively combining the functioning of the call application with the execution of the original banner.

10. The main banners module of claim 7, wherein the master container further comprises an embedded supervision code at the complied level of the original banner enables supervising over the compiled code of the original banner and the way the original code of the original banner is executed by the enhanced rich-media banner file, there by operatively combining the functioning of the call application with the execution of the original banner.

11. The main banners module of claim 7, further enables creating multiple enhanced banners by receiving complied original banners from at least one third party entity communicating through a web-service with the main banners module, through at least one communication network, and returning each created enhanced rich-media banner file to the third party entity which transmitted the original banner for enhancing.

12. A system of creating enhanced rich-media banner files, each comprising content and functionality of an original compiled ad banner file, which is a compiled rich-media file, associated therewith and a calling application enabling users to initiate a call with an advertiser, associated with the original and enhanced rich-media banner files, said system comprising:
a main banners module enabling to receive the complied code and content of an original banner and integrate the original banner with a calling application to create a new compiled enhanced rich-media banner file with calling applicability having bidirectional functionality communication with the server, wherein said creating of new complied enhanced rich-media banner file includes automatically changing or replacing the compiled original code not requiring de-compilation or recompilation of the banner original code, (wherein the non complied source original code of original banner is unavailable);
wherein the calling application can be controlled from remote sever based on calling application bidirectional functionality.
at least one advertiser's terminal, associated with at least one advertiser, enabling to communicate with at least one user, via at least one communication network; and
at least one user's terminal, enabling to communicate with at least one network page where the enhanced rich-media banner files are embedded and with the advertiser's terminal via at least one communication network,
wherein the calling application in the enhanced rich-media banner file created enables communicating the advertiser associated with the rich-media banner file with at least one user through the at least one advertiser's and user's terminals.

13. The system of claim 12, wherein the main banners module comprises:
an integration module enabling to receive the code and content of an original compiled banner and integrate the original banner with a calling application to create a new enhanced rich-media banner file with calling applicability; and
a communication module, enabling online communication with at least one enhanced rich-media banner file for managing the functionality and content of the enhanced rich-media banner file and to receive data and commands from the enhanced rich-media banner files, to supervise the calling application and to store data on the rich-media banner files;
a database enabling to store data and search for information regarding the original banners of each advertiser, calling application parameters and other details related to each advertiser;
a customization module enabling the advertiser to customize the calling application of enhanced rich-media banner files;
wherein the customization includes enabling the advertiser to input at least one calling identifier enabling to identify the advertiser's terminal for communicating with the user and to initiate a call from the advertiser's terminal to the user, to define graphical parameters of the calling application and to define functionality parameters and conditions of the calling application
wherein online communication with the enhanced rich-media banner file and managing the embedded enhanced rich-media banner files through at least one communication network of at least one type

14. The system of claim 12, wherein the main banners integration module further enables embedding a supervision code at the complied level of the compiled original banner and calling application to create the enhanced rich-media banner file, wherein the supervision code enables supervising over the content of the original banner and the way the original code of the original banner is executed by the enhanced rich-media banner file.

15. The system of claim 12, wherein the main banners module comprises a container, which includes:
a dynamic projector enabling to dynamically upload the complied code of the original banner from a remote main website; and
a calling layer, enabling to dynamically retrieve customized parameters of at least one of: the advertiser's calling application; at least parts of the calling application code from the website,
wherein the container enables creating an enhanced rich-media banner file by dynamically load the code of the compiled original banner to the enhanced rich-media banner file, once the banner is embedded in at least one network page using the dynamic projector, and
wherein the container further enables dynamically loading the parameters of the calling application to the embedded enhanced rich-media banner file, from the website, using the calling layer.

16. The main banners module of claim 7, wherein the container further comprises a supervision code, wherein the main banners module enables embedding the supervision code at the complied level of original banner, where the supervision code enables supervising over the code of the original and the way the compiled original code of the original banner is executed by the enhanced rich-media banner file, there by operatively combining the functioning of the call application with the execution of the original banner.

17. The system of claim 12, wherein the main banners module comprises a master container, which includes:
at least one compiled original banner, which is embedded in the master container as slave banner;
a projector enabling to load the compiled code and content of the slave original banner; and
a calling layer, enabling to dynamically retrieve at least one of:
customized parameters of the advertiser's calling application; at least part of the calling application code, from the website,
wherein the master container enables creating an enhanced rich-media banner file and then load the code of the original banner to the enhanced rich-media banner file from master container, using the projector, once the enhanced rich-media banner file is embedded in the at least one network page network page, and
wherein the container further enables loading at least one of: the parameters the calling application; at least part of the calling application code onto the embedded enhanced rich-media banner file, from the website, using the calling layer projector.

18. The system of claim 12 wherein the main banners module further comprises a supervision code, wherein the master container enables embedding the supervision code into the enhanced rich-media banner file at the compiled level of the original banner where the supervision code enables supervising over the compiled code of the original ad banner and the way the original banner is executed by the enhanced rich-media banner file, there by operatively combining the functioning of the call application with the execution of the original banner.

19. The method of claim 1, further comprising:
defining calling application parameters, enabling the advertiser to customize the calling tool;
creating a master container which is an enhanced rich-media banner file containing: the calling application code, a calling layer, and a projector enables loading content and compiled code from a slave original banner, which is embedded in the master container;
embedding the compiled original banner as slave in the master container;
dynamically loading the parameters of the calling application into the enhanced rich-media banner file, using the calling layer; and
loading content and compiled code from a slave original banner, which is embedded in the master container, using the projector.

20. A computer implemented binary-to-binary method of creating compiled enhanced rich-media banner files, each comprising content and functionality of an original compiled ad banner file, which is a compiled rich-media file provided without code sources, associated therewith and a calling application enabling users to initiate a call with an advertiser, wherein said advertiser is associated with the original and enhanced rich-media banner files, said method comprising:
preparing supervision code to be integrated in the original banner binary code for controlling the original ad banner Actions within the enhanced banner;
preparing a SWF Container in which the original banner is integrated with the calling application including at list one designated empty sprite and a designated code, executed by the supervision code integrated in original banner, for controlling the enhanced banner actions;
loading original compiled binary ad banner file to server's memory;
injecting the supervision code into original SWF for associating between the original banner and calling application;
inserting the modified original SWF into the empty sprite within the Container SWF to be part of the enhanced banner;
inserting a predefined Configuration SWF in the Container SWF for enabling to identify the original banner Actions within the enhance banner;
wherein all the operations relating the original banner do not require the source original code of original banner and do not require de-compilation or recompilation process.
